(19) United States
(12) Patent Application Publication
(10) Pub. No.: US 2004/0026018 A1
(43) Pub. Date: Feb. 12, 2004

(54) Method and device for coating a moving metal product strip

(76) Inventor: Petrus Cornelis Jozef, Castricum (NL)

Correspondence Address: Davis Miller & Mosher, 1615 L Street N W, Suite 850, Washington, DC, 20036, US

(21) Appl. No.: 10/276,177

(22) PCT Filed: May 18, 2001
(86) PCT No.: PCT/NL01/00381

(30) Foreign Application Priority Data
May 22, 2000 (NL) 1015260

(51) Int. Cl. B44C 1/165; B32B 31/08

(52) U.S. Cl. 156/230; 264/171.15; 264/171.17; 264/171.21; 264/171.22; 156/247; 156/289

(57) ABSTRACT

Method for coating a moving metal product strip (1), in which coating material is brought into contact with this product strip, the product strip being brought to a temperature at which the coating material is made to adhere to the product strip while the former is being pressed onto the latter, characterized in that a flexible metal support strip (6) is guided through a virtually straight path alongside this product strip at the same speed as the product strip, in that the coating material is guided over the metal support strip until it is between the product strip and the support strip, the metal support strip being locally pressed towards the metal product strip within the said path, and means being provided, at the location where pressure is exerted for equalizing the compressive force across the width of the metal support strip.

The invention relates firstly to a method for coating a moving metal product strip, in which coating material is brought into contact with this product strip, the product strip being brought to a temperature at which the coating material is made to adhere to the product strip while the former is being pressed onto the latter. In this context, the term metal product strip is understood as meaning a metal strip which is intended, after the application of a coating, to be processed and/or treated further as a product.

A method of this type is known, whereby the coating material consists of a film material, a paint or a lacquer. It is also known for a metal product strip to be coated on two sides.

In these known methods, the pressure is exerted by means of a roller. In the case of coating with a film, a web of this film is guided between the product strip to be coated (the substrate) and the pressure-exerting roller. As a result of this film being pressed onto the substrate, this film is heated and consequently adheres to the substrate.

In the case of two-sided coating, two webs of film are guided onto the substrate in a symmetrical configuration and are pressed onto the substrate by means of rollers.

The substrate, which is a metal strip, is generally obtained by rolling. This may lead to slight differences in thickness across the width of the metal strip (known as the crown). The crown of a steel strip may amount to approximately 2 to 4%. This means that a steel strip is 2 to 4% thicker in the centre than at the side edges. If the pressure-exerting rollers consist of a dimensionally rigid material, this may lead to the pressure distribution along the contact line along which the compressive force is transmitted being uneven. This may lead to local failure of the pressure-exerting rollers to come into contact with the substrate. This may in turn lead to air bubbles being included between the substrate and the film which has adhered to it, which represents a serious quality defect. To prevent this from happening, as a rule the pressure-exerting roller is provided with a rubber-like coating, so that the compressive force is better distributed.

However, this known method has serious drawbacks. The pressure-exerting roller with the rubber-like coating starts to approach the temperature of the heated film, so that there is a risk of the film material also adhering to this roller. It is not simple in technical terms for the surface of the rubber-like coating of the pressure-exerting roller to be cooled separately.

A further drawback is that the edge of the metal product strip (the substrate) damages the rubber-like coating of the roller, thus limiting the service life of the roller. This leads to high repair costs and production losses while the pressure-exerting roller is being changed. The service life of the rollers can be extended by systematically coating ever narrower metal product strip material. However, this means that it is necessary to limit the order of processing of the metal product strip material, which is often undesirable in operational terms. When processing extra-thin film material or film material with a low tear strength, problems caused by tearing or folding of the film material may arise in the known method. This also leads to serious disruptions or high rejection percentages.

The known method also has drawbacks in the coating of a substrate with a paint or lacquer.

When applying a paint based on a thermosetting polymer to the pressure-exerting roller with a rubber-like coating, the paint may adhere to the roller, since the rubber-like coating becomes too hot.

These and other drawbacks of the known method can be avoided by the use of the novel method according to the invention.

The invention therefore consists firstly in that, in the method described in the preamble, furthermore a flexible metal support strip is guided through a virtually straight path alongside this product strip at the same speed as the product strip, in that the coating material is guided over the metal support strip until it is between the product strip and the support strip, the metal support strip being locally pressed towards the metal product strip within the said path, and means being provided, at the location where pressure is exerted, for equalizing the compressive force across the width of the metal support strip.

Surprisingly, it has been found that the metal support strip according to this method, at the location where pressure is exerted, can completely follow the crown of the metal product strip if the metal support strip is pressed onto the product strip and the compressive force on the metal support strip is evened over its width. This is simplified by allowing the metal support strip to pass through a virtually straight path at the location where the pressure is exerted. This leads to the metal support strip, at the location where the pressure is exerted, having optimum bending flexibility. In this way, it is possible to obtain a coating of the metal product strip (the substrate) which is free of air bubbles.

In one embodiment, the metal support strip is locally pressed towards the metal product strip with the aid of pressure-exerting means. Inclusions are prevented, partly by the pressure-exerting means. The intervention of the metal support strip prevents direct contact between the pressure-exerting means and the coating material.

To press the support strip towards the metal product strip, it is preferable to use a roller which is brought into contact with the metal support strip. This ensures that the compressive force is exerted locally across the width of the metal support strip. The intervention of the metal support strip prevents direct contact between the roller and the coating material.

Various means are conceivable for equalizing the compressive force across the width of the metal support strip. However, according to the invention, it is preferable for the means for equalizing the compressive force to comprise a coating of a rubber-like material on the roller and/or on that side of the metal support strip which faces towards the roller.

The metal support strip can be sufficiently cooled over its length to prevent the coating material from adhering to it. This support strip may itself be coated with a rubber-like material or a metal roller coated with rubber-like material is used. In both cases, the rubber-like coating can be sufficiently cooled.

In the case of a coated pressure-exerting roller, the latter is not in direct contact with the substrate, with the result that the rubber-like coating cannot be damaged by the edges of the substrate. This considerably increases the service life of the pressure-exerting roller, so that the availability of the installation used is increased. Therefore, production planning no longer has to take the width of the substrate to be coated into account.

When processing an extra-thin film material or a film material which is susceptible to tearing, this film material can be deposited on the metal support strip at an earlier stage, so that it is supported by this support strip up to the location where the adhesion to the substrate is to be brought about.

In one embodiment, thae side of the support strip which bears the coating material is, within the virtually straight path, locally diverted and pressed onto the product strip, resulting in a bend being formed in the virtually straight path of the metal support strip, with the side that bears the coating material being situated on the outer side of the bend. This ensures that the product strip can pass through a straight path.

In one embodiment, the coating material is made to adhere to the product strip at the location where pressure is exerted while it is being pressed onto the product strip. This ensures that it is no longer necessary to maintain contact between the metal support strip and the coating material even virtually directly after the location where pressure is exerted.

This can be achieved by bringing the metal product strip to the said temperature before the metal support strip is pressed towards the metal product strip. By pressing the coating material onto the product strip, the coating material is heated and as a result adheres to the product strip. This ensures that the coating material adheres to the product strip and not to the support strip.

According to the invention, the novel method is also eminently suitable for coating the metal product strip (the substrate) on two sides, the application of a coating material to the second side being carried out in a similar way to the application to the first side, and the locations where pressure is exerted being situated symmetrically with respect to the product strip.

It has already been noted that the invention is eminently suitable for using film material as the coating material. In this case, according to the invention, preference is given to a coating material which comprises a polymer film. PET (polyethylene terephthalate) and polyolefins have been found to be particularly suitable base materials for this application.

The film material may be deposited on the metal support strip in various ways. For example, according to the invention the film may be formed by extruding a molten polymer mass onto the metal support strip via a casting die before this support strip runs through the path alongside the metal product strip (the substrate). However, according to the invention it is also quite possible firstly to extrude a film and then for this film to be stretched before being deposited on the metal support strip. The invention has made numerous variants for the coating of a substrate possible.

Apart from the option of forming a film first of all, according to the invention it is also possible for a solvent-free material selected from the group consisting of binders which cure to form a three-dimensional network to be extruded onto the metal support strip via a casting die before this support strip runs through the path alongside the metal product strip.

This material only cures to form a layer of paint which adheres to the substrate and comes off the metal support strip when this material is heated at the location where the pressure is exerted. The location of extrusion of the material may in this case be sufficiently far away from the location where pressure is exerted to avoid design and operational problems.

Obviously, according to the invention it is also possible for a different coating material to be applied to the two sides of the substrate, for example two different polymer films, different types of paint or a polymer film on one side and a paint on the other side.

The selection of coating material for coating a metal substrate is amply described in the specialist literature. For this reason, the coating materials which are suitable for the novel method are not described in further detail here.

It has already been noted that, with the method according to the novel invention, it is possible to prevent air bubbles from forming beneath the coating applied to the substrate. By virtue of the fact that the metal support strip is flexible and runs through a virtually straight path at the location where the pressure is exerted, the exertion of pressure by, for example, a rubber-coated roller can be sufficiently evened out, so that the metal support strip virtually completely follows the irregularities in the surface of the substrate. If this effect nevertheless proves insufficient, according to the invention it may furthermore be recommended for the metal support strip(s) together with the coating material, before being pressed towards the metal product strip, to be guided through a gas lock together with the metal product strip.

Depending on the roughness of the substrate, but especially if the substrate has pores or small scratches, air contained therein may be retained while the coating material is being pressed on. This may lead to the formation of gas bubbles in the finished product. If the gas lock comprises a vacuum chamber, air in pores or scratches has already been evacuated before the coating material is pressed on. This prevents the formation of air bubbles.

The introduction into and removal from a vacuum chamber and maintaining a vacuum may cause design and operational problems. As an alternative to maintaining a vacuum in the gas lock, according to the invention it has also proven successful for a helium atmosphere at a slight superatmospheric pressure to be maintained in the gas lock. If helium gas is included while coating material is being pressed onto a substrate, it has been found that helium can easily escape through the coating material by diffusion. Consequently, no bubbles are then formed beneath the coating layer on the substrate. By providing the helium atmosphere within the gas lock with a slight superatmospheric pressure, air is prevented from entering the gas lock.

It has already been noted that the metal support strip can be cooled more easily than a simple pressure-exerting roller. This is partly because of the larger cooling surface of this strip. Preferably, according to the invention, the metal support strip and the roller with a rubber-like coating are held at a temperature which lies below the temperature at which fixed adhesion of the coating material to the metal support strip occurs.

It is conceivable for the metal support strip to be unwound from a coil. However, according to the invention, preference is clearly given to a method in which the metal support strip is an endless strip which comprises thin stainless steel strip material. This strip can then be pressed on by a roller with a rubber-like coating. This roller may in turn preferably be supported by a driven and cooled steel support roller. The compressive force then does not cause the shaft of the pressure-exerting roller to bend.

According to the invention, favourable conditions for operation of the novel method are found if the metal support strip is held at a temperature between 10 and 120° C., the rubber-like coating has a hardness of between 50 and 90 SHORE A and the roller is pressed onto the metal support strip with a force of between 20 and 80 kg per cm of the contact line with the metal support strip.

It is especially preferred for the temperature in question to be held at between 30 and 75° C., the hardness in question is selected to be between 70 and 85 SHORE A and the compressive force is selected to be between 30 and 60 kg per cm of the contact line.

More particularly, the metal support strip should be held at a temperature at which the coating material cannot adhere to it or form a fixed bond with it. If the coating material is an organic material which is in an amorphous state or is a prepolymer which is thermosetting or UV-curing, the temperature of the metal support strip must remain below the glass transition temperature T_{g} of the coating material.

For example, when using PET (of which T_{g}=75° C.), this temperature must preferably remain at <70° C. If the coating material is a (semi-)crystalline organic material, the temperature of the metal support strip must remain below the melting temperature Tₘ of the coating material. For example when using a polypropylene PP (of which Tₘ=160° C.), the temperature of the support strip should preferably remain at <150° C.

However, the temperature of the coating material must still provide this coating material with the opportunity to adapt to the microroughness of the product strip, so that no air is included during the coating process. The coating material in this case serves to obtain “vacuum adhesion” to the product strip.

The minimum temperature required is a function of various factors, such as the chemical structure of the coating material, its thickness, the original temperature on application to the support strip and the heat content of this support strip.

If a coating material, for example a film, is too cold, this film cannot maintain sufficient contact with the metal support strip. This may cause the film to break or to folds being formed in the coating layer on the substrate.

As well as the novel method, the invention also relates to a novel device for coating a moving metal product strip, comprising a product course along which the metal product strip to be coated can be advanced.

According to the invention, the device is characterized in that a metal support strip is guided over a course over a drive roller and a number of guide rollers, which course comprises a virtually straight path which runs alongside the product course, means being present for feeding coating material to a part of the course of the metal support strip, and the device is provided with pressure-exerting means which are in contact with the support strip along its virtually straight path and locally press the support strip towards the product course, means for equalizing the compressive force across the width of the metal support strip being provided at the location where the pressure is exerted.

According to the invention, this novel device may also, on either side of the course of the metal product strip, be of double-sided design. Furthermore, this novel device may be provided with means for implementing one or more described embodiments of the method described above.

The invention will now be explained with reference to two figures.

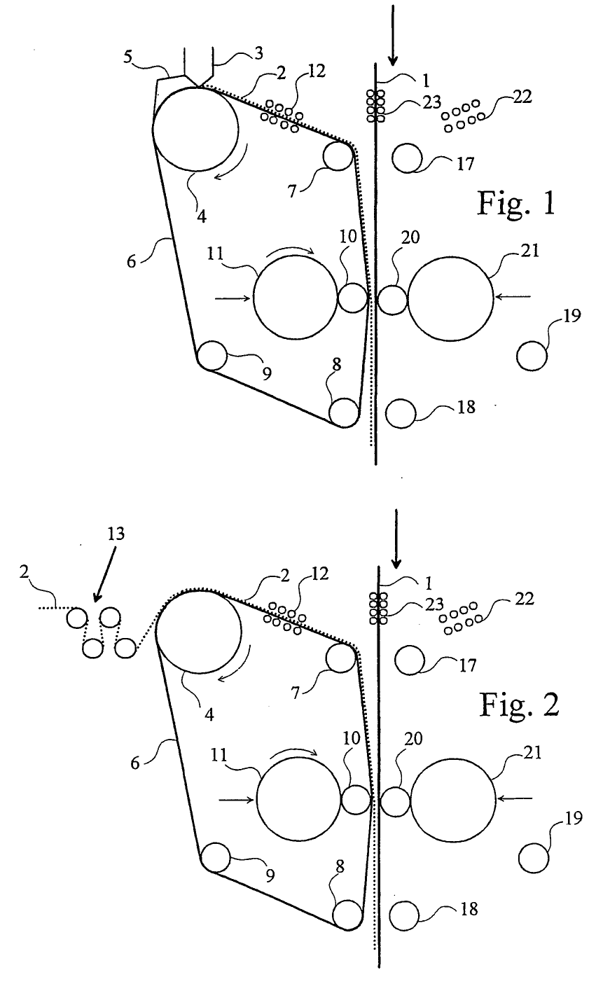

FIG. 1 diagrammatically depicts a device for coating a substrate according to the invention.

FIG. 2 shows a variant of this device.

In FIG. 1, reference numeral 1 denotes a steel product strip which is to serve as a substrate for the application of coating material 2. Substrate 1 moves vertically downwards. An endless stainless steel strip 6 runs over a driven roller 4 and over guide rollers 7, 8 and 9.

If substrate 1 is being coated on two sides, the device may of symmetrical design. Guide rollers 17, 18 and 19 are also diagrammatically illustrated for this purpose.

In FIG. 1, a casting die 3 is positioned above the roller 4, and above the endless strip 6 which is guided over this roller and is driven thereby. If the casting die 3 is connected to an extruder (not shown), a molten polymer mass can be extruded out of the casting die 3, and this is formed into a film 2 on the endless strip 6. This film 2 is supported by strip 6 and as a result is not subjected to load or deformation while it is being transported on the strip 6.

Between guide rollers 7 and 8, strip 6 passes through a virtually straight path alongside the course of the substrate 1. About halfway along this path, strip 6 is pressed towards the substrate 1 by a roller 10 with a rubber-like coating. In the process, film 2 is pressed onto the substrate at this location. Substrate 1 is preheated by a furnace (not shown) to a temperature at which the film, under the pressure from roller 10, is made to adhere to the substrate 1.

Since the strip 6 is held at a temperature which lies below a temperature at which the plastic film 2 adheres to the stainless steel surface of the strip 6, this film 2 comes off the strip 6 after it has passed the roller 10.

Since strip 6 is pressed onto the substrate 1 in a virtually straight path and since strip 6 is a thin strip, it can readily follow the profile of the substrate 1, especially if the device is of double-sided design. This is further improved by the fact that roller 10 is provided with a rubber-like coating which evens the compressive force exerted by roller 10 across the width of the substrate 1. Roller 10 itself is supported and subjected to pressure by a heavy cooled steel roller 11, with the result that roller 10 itself is not subjected to flexural loads. It is preferable for roller 11 to be driven.

It should be noted that strip 6 may also be provided with a rubber-like coating on the rear side, as well as or instead of the rubber-like coating of the roller 10. The equalizing of the compressive force by the rubber-like coating ensures that no gas bubbles are formed beneath the coating on substrate 1. The point where substrate 1 and strip 6 together with the film 2 converge may be located within a vacuum cabinet or within a chamber with a hot superatmospheric pressure of helium gas. Gas locks 12, 22 and 23 are diagrammatically indicated for this purpose. The further construction of a vacuum cabinet or a chamber with superatmospheric helium gas pressure of this type forms part of conventional technology which has not been described in more detail here for the person skilled in the art.

To ensure uniform casting of a film at high speed, it may be important for a vacuum cabinet 5 to be positioned in the vicinity of the casting die.

It should be noted that a device in accordance with FIG. 1 can also be used, with little adaptation, to apply a layer of paint to the substrate 1. In this case, instead of a molten polymer a solvent-free material is extruded, which cures at elevated temperature to form a three-dimensional network. Instead of using an elevated temperature, it is also possible for this material to be cured by irradiating it with light of short wavelength (UV light) or with electrons (electron beam). The curing then takes place at the location of a reheating section after the as yet uncured coating has been applied to steel strip 1.

FIG. 2 shows a variant of the device shown in FIG. 1. In this variant, the film 2 is not cast onto the strip 6, but rather has already been prefabricated. The figure diagrammatically depicts a situation in which a film which has already been cast is guided through a stretching installation 13. The stretched film is then deposited on the strip 6 at the location of roller 4. Then, the treatment of the film takes place in the same way as in the case of a film which has been extruded as described in connection with FIG. 1.

1. Method for coating a moving metal product strip, in which coating material is brought into contact with this product strip, the product strip being brought to a temperature at which the coating material is made to adhere to the product strip while the former is being pressed onto the latter, characterized in that a flexible metal support strip is guided through a virtually straight path alongside this product strip at the same speed as the product strip, in that the coating material is guided over the metal support strip until it is between the product strip and the support strip, the metal support strip being locally pressed towards the metal product strip within the said path, and means being provided, at the location where pressure is exerted, for equalizing the compressive force across the width of the metal support strip.

2. Method according to claim 1, characterized in that the metal support strip is locally pressed towards the metal product strip with the aid of pressure-exerting means.

3. Method according to claim 1, characterized in that for exerting said pressure a roller is used, which roller is brought into contact with the metal support strip.

4. Method according to claim 3, characterized in that the means for equalizing the compressive force comprise a coating of a rubber-like material on the roller and/or on that side of the metal support strip which faces towards the roller.

5. Method according to one of the preceding claims, characterized in that the side of the support strip which bears the coating material is, within the virtually straight path, locally diverted and pressed onto the product strip, resulting in a bend being formed in the virtually straight path of the metal support strip, with the side that bears the coating material being situated on the outer side of the bend.

6. Method according to one of the preceding claims, characterized in that the coating material is made to adhere to the product strip at the location where pressure is exerted while it is being pressed onto the product strip.

7. Method according to one of the preceding claims, characterized in that the metal product strip is brought to the said temperature before the metal support strip is pressed towards the metal product strip.

8. Method according to one of the preceding claims, characterized in that the metal product strip is coated on two sides, the application of a coating material to the second side being carried out in a similar way to the application to the first side, and the locations where pressure is exerted being situated symmetrically with respect to the product strip.

9. Method according to one of claims 1 to 8 inclusive, characterized in that the coating material, on at least one side of the metal product strip, comprises a solvent-free material selected from the group consisting of binders which cure to form a three-dimensional network, which material is extruded onto the metal support strip via a casting die before this metal support strip runs through the path alongside the metal product strip.

10. Method according to one of claims 1 to 8 inclusive, characterized in that the coating material comprises a polymer film on at least one side of the metal product strip.

11. Method according to claim 10, characterized in that the (each) film is extruded onto the metal support strip via a casting die before the support strip runs through the path alongside the metal product strip.

12. Method according to claim 10, characterized in that the (each) film is a stretched film which is guided onto the metal support strip before the support strip runs through the path alongside the metal product strip.

13. Method according to one of the preceding claims, characterized in that the (each) metal support strip, together with the coating material which is present thereon, before being pressed towards the metal product strip, is guided through a gas lock together with the metal product strip.

14. Method according to claim 13, characterized in that the gas lock comprises a vacuum chamber.

15. Method according to claim 13, characterized in that a helium atmosphere at superatmospheric pressure is maintained in the gas lock.

16. Method according to one of the preceding claims, characterized in that the metal support strip used is an endless strip which comprises thin stainless steel strip material.

17. Method according to one of the preceding claims, characterized in that the metal support strip is held at a temperature which lies below the temperature at which fixed adhesion of the coating material to the metal support strip occurs.

18. Method according to one of claims 3 to 17 inclusive, characterized in that the roller is supported by a driven and cooled steel support roller.

19. Method according to one of claims 4 to 18 inclusive, characterized in that the metal support strip is held at a temperature between 10 and 120° C., in that the rubber-like coating has a hardness of between 50 and 90 SHORE A, and in that the roller is pressed against the metal support strip with a force of between 20 and 80 kg per cm of the contact line with the metal support strip.

20. Method according to claim 19, characterized in that the temperature in question is held between 30 and 75° C., in that the hardness in question is selected to be between 70 and 85 SHORE A, and in that the compressive force is selected to be between 30 and 60 kg per cm of the contact line.

21. Method according to claim 19 or 20, characterized in that the metal support strip is held at a temperature which lies below the glass transition temperature T_{g} of the coating material if this material is in an amorphous state or below the melting point Tₘ if the coating material is (semi-)crystalline.

22. Device for coating a moving metal product strip, comprising a product course along which the metal product strip to be coated can be advanced, characterized in that a metal support strip is guided over a course over a drive roller and a number of guide rollers, which course comprises a path which runs alongside the product course, means being present for feeding coating material to a part of the course of the metal support strip, and the device is provided with pressure-exerting means which are in contact with the support strip along its virtually straight path and locally press the support strip towards the product course, means for equalizing the compressive force across the width of the metal support strip being provided at the location where the pressure is exerted.

23. Device according to claim 22, characterized in that the pressure-exerting means comprise a roller.

24. Device according to claim 23, characterized in that the means for equalizing the compressive force comprise a coating of a rubber-like material on the roller and/or on that side of the metal support strip which faces towards the roller.

25. Device according to one of claims 22 to 24 inclusive, characterized in that the device, on either side of the course of the metal product strip, is of double-sided design.
